(19) United States
(12) Patent Application Publication
(10) Pub. No.: US 2011/0010662 A1
(43) Pub. Date: Jan. 13, 2011

(54) SYSTEM AND METHOD FOR VISUALIZING TREND DATA

(75) Inventors: Danqing Zhang, Podung New Area (CN); Chenzhou Ye, Shanghai (CN); Ming Ge, Shanghai (CN); Guan Tien Tan, Shanghai (CN)

Correspondence Address: HONEYWELL/SLW;Patent Services, 101 Columbia Road, P.O. Box 2245, Morristown, NJ, 07962-2245, US

(73) Assignee: Honeywell International Inc., Morristown, NJ (US)

(21) Appl. No.: 12/738,648

(22) PCT Filed: Oct. 26, 2007
(86) PCT No.: PCT/CN07/03054

§ 371 Date: Sep. 9, 2010

(51) Int. Cl. G06F 3/048

(52) U.S. Cl. 715/806; 715/856; 715/781

(57) ABSTRACT

One embodiment of the application provides a system for visualizing trend data of an industrial performance (e.g., utility consumption) of a power plant. The system includes a macro trend view generator, navigator, a pointer position calculator, and a micro trend view controller. The macro trend view generator is configured to generate a macro trend view of a sensed parameter in a display. The navigator is configured to navigate a pointer for locating an area in the macro trend view. The pointer position calculator is configured to calculate a position of the pointer in the macro trend view. The micro trend view controller is configured to generate a micro trend view associated with the located area in the display, as a function of the calculated position of the pointer in the macro trend view.

### TECHNICAL FIELD

The present application relates generally to the technical field of visualization of trend data.

### BACKGROUND

Typically, a Supervisory Information System (SIS) is designed to manage, monitor and optimize the overall performance of a power plant. A typical SIS normally contains tools, which are modularized software packages to read trend data from a database, perform calculations, and write the results back to the database. However, a conventional SIS suffers from a problem that the displayed trend data is not convenient for a viewer, who wants to see both the overview trend data and more detailed trend data at the same time.

### BRIEF DESCRIPTION OF THE DRAWINGS

Some embodiments are illustrated by way of examples, and not by way of limitations, in the figures of the accompanying drawings in which:

FIG. 1 is a diagram illustrating a GUI interface displaying at the same time both a macro trend view and a micro trend view of coal pulverizer current of a power plant according to an example embodiment;

FIG. 2 is a block diagram illustrating the structure of the trend data visualization of a supervisory information system according to an example embodiment;

FIG. 3 is a block diagram illustrating modules of a trend data processor of the supervisory information system shown in FIG. 2 according to an example embodiment;

FIG. 4 is a flowchart illustrating a method for visualizing trend data of coal pulverizer current of a power plant according to an example embodiment;

FIG. 5 is a flowchart illustrating a method for visualizing trend data of coal pulverizer current of a power plant according to another example embodiment; and

FIG. 6 is a block diagram illustrating a machine in the example form of a computer system having a set of instructions for causing the machine to perform any one of the methodologies discussed herein may be executed.

### DETAILED DESCRIPTION

In the following description, for purposes of explanation, numerous specific details are set forth in order to provide a thorough understanding of example embodiments. It will be evident, however, to one skilled in the art that the embodiments of the application may be practiced without these specific details.

The term “SIS” used in the following description denotes a “Supervisory Information System”, which is designed to manage, monitor and optimize an industrial performance as represented by a sensed parameter, e.g., coal pulverizer current of a power plant.

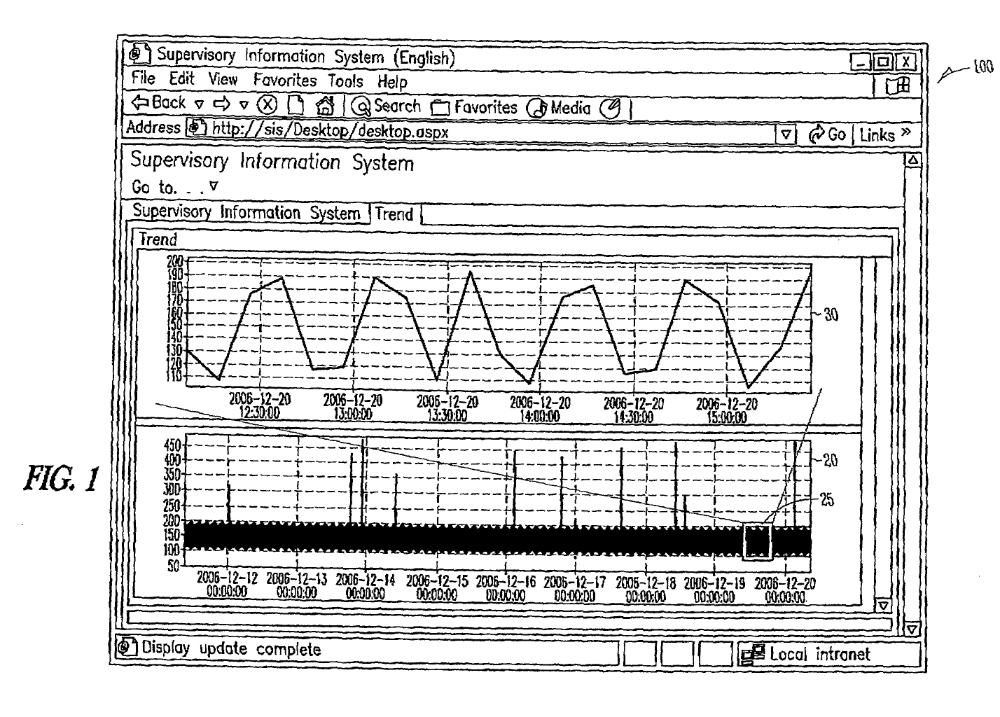

FIG. 1 is a diagram illustrating a GUI interface 100 displaying at the same time both a macro trend view 20 and a micro trend view 30 of coal pulverizer current of a power plant for a time interval generated by a supervisory information system according to an example embodiment. In the example embodiment, an industrial performance (e.g., coal pulverizer current) trend graph is visualized in two levels with the aid of a navigator.

The macro trend view 20 may illustrate an overall industrial performance trend of a power plant over a period of time, e.g., a coal pulverizer current (Unit: A) trend changing over eight days. In one embodiment, the period of time may vary from short times (e.g., hours) to long times (e.g., days, weeks, or years). The macro trend view 20 may have a start time (e.g., 12/12/2006), an end time (e.g., 12/20/2006), and a time interval (e.g., one day). In the macro trend view 20, a rectangular navigation pointer 25 may point to or locate an interesting sub-period of time confined between the start time and the end time of the macro trend view 20.

On the other hand, the micro trend view 30 provides a more detailed industrial performance trend within the interesting sub-period of time located by navigator pointer 25. As shown in FIG. 1, the interesting area represents the coal pulverizer current (Unit: A) trend changing within three hours. The micro trend view 30 starts from 12/20/2006, 12:00:00, ends at 12/20/2006, 15:00:00, and has a time interval of half hour. The reduced time period allows more detail to be illustrated, such as current values at specific times that are not viewable in the macro trend view. The start time and the end time of the micro trend view 30 are determined by the position of the navigation pointer 25 in the macro trend view 20. For example, the position of the front side of the rectangular navigation pointer 25 in the macro trend view 20 determines the start time of the micro trend view 30. The position of the back side of the rectangular navigation pointer 25 in the macro trend view 20 determines the end time of the micro trend view 30.

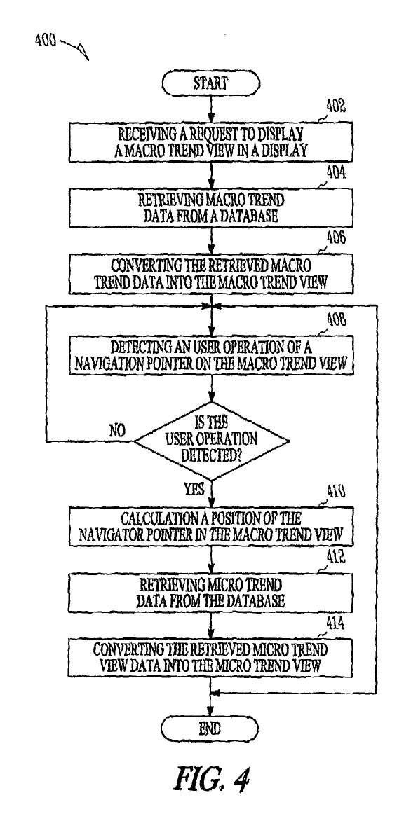

By the aid of a navigator 62 (which is not shown in FIG. 1, but is shown in FIG. 3), a user may move the navigation pointer 25 to locate a new interesting area in the macro trend view 20. The SIS 200 may therefore display the micro trend view 30 of the new located area. In one example embodiment, the micro trend view 30 is about the same size as the macro trend view 20, and may appear to be in a separate window. Lines may extend from the pointer 25 to correlate the micro trend view 30 to the portion of the macro trend view 20 identified by the pointer 25. In an example embodiment, the navigation pointer 25 is a text cursor. In another example embodiment, the navigation pointer 25 is a rectangular mouse pointer.

The layout of macro and micro trend view windows and the shape of the navigation pointer is not limited to the above example embodiments. For example, the navigation pointer can be in other conventional forms or shapes.

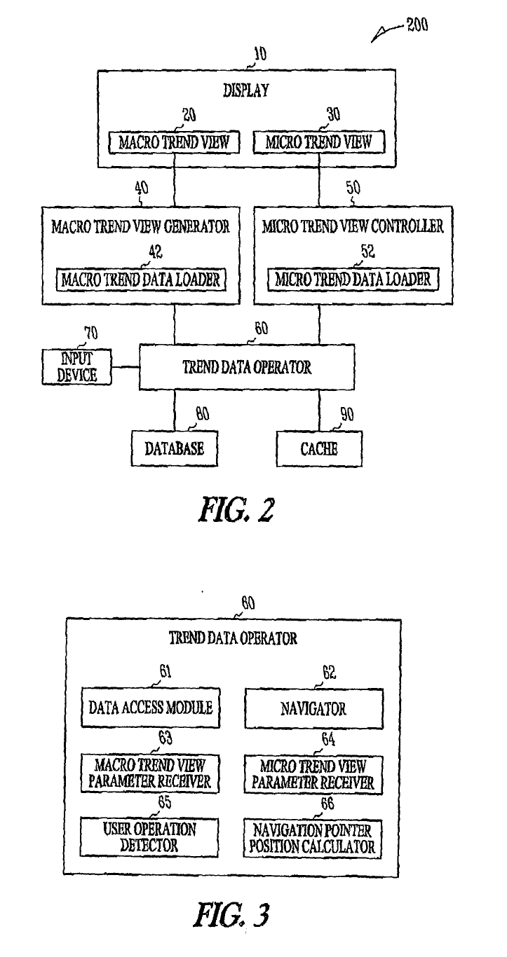

FIG. 2 is a block diagram illustrating the structure of the trend data visualization of a supervisory information system (SIS) 200 according to an example embodiment. The SIS 200 may display both a macro trend view and a micro trend view in a display at the same time. In the example embodiment, the SIS 200 may include a display 10 to display at the same time both a macro trend view 20 and a micro trend view 30 (e.g., as shown in FIG. 1), a macro trend view generator 40, a micro trend view controller 50, a trend data operator 60, an input device 70, a database 80, and a cache 90.

FIG. 3 is a block diagram illustrating modules of the trend data processor 60 of the SIS 200 shown in FIG. 2. In the example embodiment, the trend data processor 60 of the SIS 200 may include a data access module 61, a navigator 62, a macro trend view parameter receiver 63, a micro trend view parameter receiver 64, a user operation detector 65, and a navigation pointer position calculator 66.

Referring back to FIG. 2, in an example embodiment, the database 80 may contain data or information about industrial performance (for example, a coal pulverizer current trend) of the power plant. In some example embodiments, the database may contain historical data, real time data, trend parameters, calculation results associated with a industrial performance, e.g., the coal pulverizer current (Unit: A) trend. An update device may, for example, update the real time data in the database 80.

In an example embodiment, the input device 70 may be used to enter macro trend view monitoring parameters, e.g., a start time, an end time, an interval and a magnification factor for displaying the macro trend view 20 in the display 10. In another example embodiment, the macro trend view monitoring parameters are default parameters set by the system. A macro trend view monitoring parameter receiver 63 may, for example, receive the entered or the default macro trend view monitoring parameters.

In an example embodiment, based on the macro trend view monitoring parameters, the trend data operator 60 may use the data access module 61 to retrieve macro trend data from the database 80. The trend data operator 60 may then transmit the retrieved macro trend data to the macro trend data loader 42. The macro trend data loader 42 may load the macro trend data, and then convert the loaded macro trend data into the macro trend view 20 to display in the display 10.

In an example embodiment, a user may use the navigator 62 to browse the macro trend view 20 to locate the navigation pointer 25 in an interesting area within the macro trend view 20. The navigation pointer position calculator 66 may then calculate the position of the navigation pointer 25 within the macro trend view 20. As shown in FIG. 1, the navigation pointer 25 may be, for example, in the shape of a rectangle. From the calculated position of the navigation pointer 25, the micro trend view parameter receiver 64 may obtain the micro trend view monitoring parameters, e.g., a start time and an end time of the micro trend view 30. For example, the front side of the rectangular navigation pointer 25 may determine the start time of the micro trend view 30, and the back side of the rectangular navigation pointer 25 may determine the end time of the micro trend view 30.

In an example embodiment, base on the start time and the end time of the micro trend view monitoring parameters, the trend data operator 60 may use the data access module 61 to retrieve micro trend data from the database 80. The trend data operator 60 may then transmit the retrieved micro trend data to the micro trend data loader 52. After that, The trend data operator 60 may then transmit the retrieved micro trend data to the micro trend data loader 52. The micro trend data loader 52 may load the micro trend data, and then convert the loaded micro trend data into the micro trend view 30 to display in the display 10.

In an example embodiment, the user operation detector 50 may be used to detect the occurrence of a user operation, e.g., the movement of the navigation pointer 25 in the macro trend view 20 to trigger the generation of the micro trend view 30 in the display 10.

In an example embodiment, after the macro trend view data being retrieved, the SIS 200 may use a cache 90 to store the retrieved macro trend data for future use. The stored macro trend view data may be used in future to generate an associated micro trend view 30. As a result, the time needed for retrieving the micro trend data can be reduced.

In one example embodiment, the macro trend view 20 may illustrate in real time an overall industrial performance trend of a power plant over a period of time, e.g., a coal pulverizer current (Unit: A) trend changing over one day. The end time of the macro trend view 20 may be set as the present time (or a time behind of the present time by a very short time, e.g., 2 seconds), and the start time of the macro trend view 20 may be set as a time behind of the present time by the period of time (e.g., one day) of the macro trend view 20. With the macro trend view 20 monitoring in real time the overall industrial performance trend, a micro trend view 30 may be generated in the ways as illustrated in any of the above embodiments, and therefore may monitor a corresponding micro trend view 30 in real time.

In one embodiment, an refresh or update device may be used to refresh or update in real time the industrial performance data stored in the database 80. The industrial performance data may also come from other resources than the database 80. For example, the industrial performance data can come from a input device or other systems than the SIS 200.

FIG. 4 is a flowchart illustrating a method 400 for visualizing trend data of coal pulverizer current of a power plant according to an example embodiment.

As shown in FIG. 4, at 402, a request to display a macro trend view 20 in a display 10 is received. The request may, for example, include macro trend view monitoring parameters.

At 404, macro trend data is retrieved from a database 80 as a function of the macro trend view monitoring parameters.

At 406, the retrieved macro trend data is converted into the macro trend view 20 to display in the display 10.

At 408, a navigation pointer 25 on the macro trend view 20 is detected to find any user operation to the navigation pointer 25.

At 410, if the user operation detected, the position of the navigation pointer 25 in the macro trend view 20 is calculated. The position of the navigation pointer 25 may, for example, determine the start time and the end time of the micro trend view 30 to be generated.

At 412, micro trend data is retrieved as a function of the calculated position of the navigation pointer 25.

At 414, the retrieved micro trend view data is converted into the micro trend view 30 to display in the display 10.

In some example embodiments, after retrieving the macro trend data at 404, the SIS 200 may store the retrieved macro trend data in a cache 90 (as shown in FIG. 2) for future use in generating the micro trend view 30. As a result, when generating the micro trend view 30, the SIS 200 may efficiently retrieve the micro trend data from the cache 90 (instead of from the database 80), and thus may reduce the retrieving time of the micro trend data.

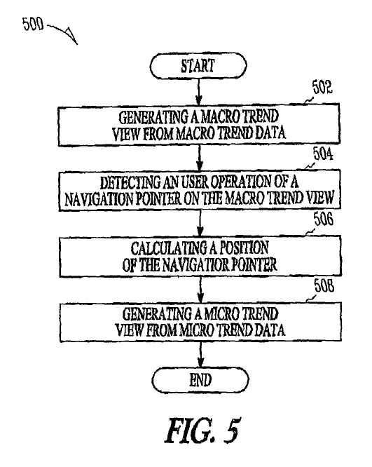

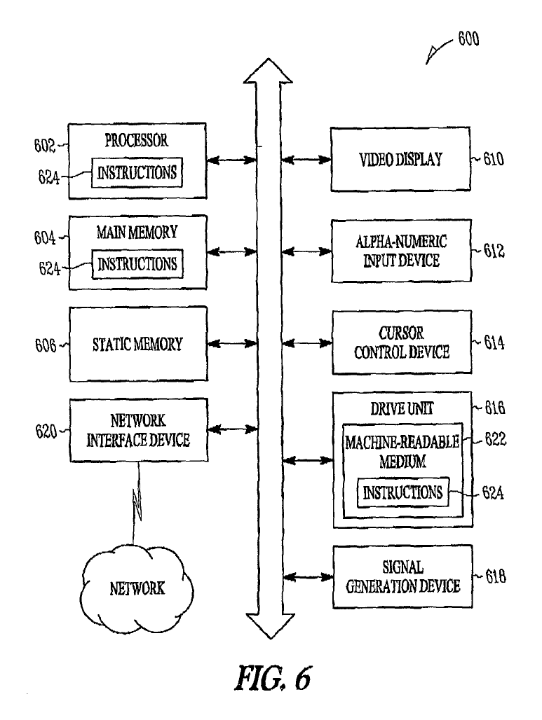

FIG. 5 is a flowchart illustrating a method 500 for visualizing trend data of utility production of a power plant according to another example embodiment.

As shown in FIG. 5, at 502, a macro trend view is generated from macro trend data.

At 504, a user operation of a navigation pointer on the macro trend view is detected.

At 506, a position of the navigation pointer is calculated.

At 508, a micro trend view is generated from micro trend data as a function of the calculated position of the navigation pointer.

In some example embodiments, the macro trend data is stored in a cache 90 (as shown in FIG. 2) for future use in generating the micro trend view 30. As a result, when generating the micro trend view 30, the SIS 200 may efficiently retrieve the micro trend data from the cache 90 (instead of from the database 80), and thus may reduce the retrieving time of the micro trend data.

FIG. 6 is a block diagram illustrating a machine in the example form of a computer system 600, within which a set of sequence of instructions for causing the machine to perform any one of the methodologies discussed herein may be executed.

In some embodiments, the machine may be a server computer, a client computer, a personal computer (PC), a tablet PC, a set-top box (STB), a Personal Digital Assistant (PDA), a cellular telephone, a web appliance, a network router, switch or bridge, or any machine capable of executing a set of instructions that specify actions to be taken by that machine. Further, while only a single machine is illustrated, the term “machine” shall also be taken to include any collection of machines that individually or jointly execute a set of instructions to perform any one or more of the methodologies discussed herein.

The example computer system 600 includes a processor 602 (e.g., a central processing unit (CPU) a graphics processing unit (GPU) or both), a main memory 604 and a static memory 606, which communicate with each other via a bus 608. The computer system 600 may further include a video display unit 610 (e.g., a liquid crystal display (LCD) or a cathode ray tube (CRT)). The computer system 600 also includes an alphanumeric input device 612 (e.g., a keyboard), a cursor control device 614 (e.g., a mouse), a disk drive unit 616, a signal generation device 618 (e.g., a speaker) and a network interface device 620.

The disk drive unit 616 includes a machine-readable medium 622 on which is stored one or more sets of instructions (e.g., software 624) embodying any one or more of the methodologies or functions described herein. The software 624 may also reside, completely or at least partially, within the main memory 604 and/or within the processor 602 during execution thereof by the computer system 600, the main memory 604 and the processor 602 also constituting machine-readable media.

The software 624 may further be transmitted or received over a network 626 via the network interface device 620.

While the machine-readable medium 622 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the present invention. The term “machine-readable medium” shall accordingly be taken to include, but not be limited to, solid-state memories, optical and magnetic media, and electromagnetic signals.

The above-described steps can be implemented using standard programming techniques. The novelty of the above-described embodiment lies not in the specific programming techniques but in the use of the methods described to achieve the described results. Software programming code which embodies the present application is typically stored in permanent storage. In a client/server environment, such software programming code may be stored in storage associated with a server. The software programming code may be embodied on any of a variety of known media for use with a data processing system, such as a diskette, or hard drive, or CD ROM. The code may be distributed on such media, or may be distributed to users from the memory or storage of one computer system over a network of some type to other computer systems for use by users of such other systems. The techniques and methods for embodying software program code on physical media and/or distributing software code via networks are well known and will not be further discussed herein.

It will be understood that each element of the illustrations, and combinations of elements in the illustrations, can be implemented by general and/or special purpose hardware-based systems that perform the specified functions or steps, or by combinations of general and/or special-purpose hardware and computer instructions.

These program instructions may be provided to a processor to produce a machine, such that the instructions that execute on the processor create means for implementing the functions specified in the illustrations. The computer program instructions may be executed by a processor to cause a series of operational steps to be performed by the processor to produce a computer-implemented process such that the instructions that execute on the processor provide steps for implementing the functions specified in the illustrations. Accordingly, the figures support combinations of means for performing the specified functions, combinations of steps for performing the specified functions, and program instruction means for performing the specified functions.

As a result of the application, it is convenient for users to monitor at the same time both an overall macro trend and a more detailed micro trend view of an industrial performance, e.g., coal pulverizer current of a power plant.

While there has been described herein the principles of the application, it is to be understood by those skilled in the art that this description is made only by way of example and not as a limitation to the scope of the application. Accordingly, it is intended by the appended claims, to cover all modifications of the application which fall within the true spirit and scope of the application.

1. A system for visualizing trend data of a sensed parameter, comprising:
a macro trend view generator configured to generate a macro trend view of sensed parameter in a display;
a navigator configured to navigate a pointer for locating an area in the macro trend view;
a pointer position calculator configured to calculate a position of the pointer in the macro trend view; and
a micro trend view controller configured to generate a micro trend view associated with the located area in the display, as a function of the calculated position of the pointer in the macro trend view.

2. The system of claim 1, further comprising a user operation detector configured to detect a user operation to the macro trend view.

3. The system of claim 1, wherein the pointer is in a rectangular shape, and positions of a pair of parallel sides of the rectangular pointer in the macro trend view determine start and end times of the micro trend view.

4. The system of claim 1, further comprising a macro trend view monitoring parameter receiver configured to receive macro trend view monitoring parameters from an input device.

5. The system of claim 4, wherein the macro trend view monitoring parameters includes start time, end time, and time interval of the macro trend view.

6. The system of claim 1, further comprising a micro trend view monitoring parameter adjuster configured to adjust a micro trend view monitoring parameter.

7. The system of claim 1, further comprising a data access module configured to retrieve data from a database for generating the macro trend view.

8. The system of claim 7, further comprising a cache configured to store the retrieved data from the database for generating the micro trend view.

9. A method for visualizing trend data of a sensed parameter, comprising:
receiving a request to display a macro trend view in a display, the request includes macro trend view monitoring parameters;
retrieving macro trend data from a database as a function of the macro trend view monitoring parameters;
converting the retrieved macro trend data into the macro trend view to display in the display;
detecting a user operation of a navigation pointer on the macro trend view;
if the user operation detected, calculating a position of the navigation pointer in the macro trend view;
retrieving micro trend data as a function of the calculated position of the navigation pointer; and
converting the retrieved micro trend view data into the micro trend view to display in the display.

10. The method of claim 9, further comprising: after retrieving the macro trend data, storing the retrieved macro trend data in a cache to be future used for generating the micro trend view.

11. The method of claim 10, wherein the retrieving micro trend data includes retrieving the micro trend data from the cache as a function of the calculated position of the navigation pointer.

12. A method for visualizing trend data of utility consumption, comprising:
generating a macro trend view from macro trend data;
detecting a user operation of a navigation pointer on the macro trend view;
calculating a position of the navigation pointer; and
generating a micro trend view from micro trend data as a function of the calculated position of the navigation pointer.

13. The method of claim 12, further comprising storing the macro trend data in a cache to be future used for generating the micro trend view.

14. The method of claim 13, wherein the generating a micro trend view from micro trend data includes retrieving the micro trend data from the cache as a function of the calculated position of the navigation pointer.

15. A machine-readable medium comprising instructions, which when implemented by one or more processors, perform the following operations:
receiving a request to display a macro trend view in a display, the request includes macro trend view monitoring parameters;
retrieving macro trend data from a database as a function of the macro trend view monitoring parameters;
converting the retrieved macro trend data into the macro trend view to display in the display;
detecting a user operation of a navigation pointer on the macro trend view;
if the user operation detected, calculating a position of the navigation pointer in the macro trend view;
retrieving micro trend data as a function of the calculated position of the navigation pointer; and
converting the retrieved micro trend view data into the micro trend view to display in the display.

16. The computer-readable medium of claim 15, further comprising instructions, which when implemented by one or more processors, perform the following operation: after retrieving the macro trend data, storing the retrieved macro trend data in a cache to be future used for generating the micro trend view.

17. The computer-readable medium of claim 16, wherein the retrieving micro trend data includes retrieving the micro trend data from the cache as a function of the calculated position of the navigation pointer.

18. A graphical user interface (GUI) of a trend data view of a sensed parameter, comprising:
a first region displaying a macro trend view associated with utility consumption;
a second region displaying a navigation pointer to locate an area within the first region; and
a third region displaying a micro trend view of the located area, the micro trend view is a magnified view of the located area from the macro trend view.

19. The GUI of claim 18, further the navigation pointer is a text cursor.

20. The GUI of claim 18, further the navigation pointer is a rectangular mouse pointer.
